(19) United States
(12) Patent Application Publication
(10) Pub. No.: US 2011/0202379 A1
(43) Pub. Date: Aug. 18, 2011

(54) Personalized uniform resource locator contact management system

(76) Inventor: Bihari K. Srinivasan, Andover, MA (US)

(21) Appl. No.: 12/931,650

(22) Filed: Feb. 7, 2011

Related U.S. Application Data
(60) Provisional application No. 61/337,671, filed on Feb. 8, 2010.

(51) Int. Cl. G06Q 10/00

(52) U.S. Cl. 705/7.13

(57) ABSTRACT

Real-time notification of customers using communication channels such as email and the web that enables intelligent routing of the notification based on user generated rules.

### CROSS REFERENCE TO RELATED APPLICATIONS

The present application claims the benefit of Provisional Patent Application Ser. No. 61/337,671 filed on Feb. 8, 2010, which is incorporated herein by reference.

### TECHNICAL FIELD OF THE INVENTION

The present invention relates to the field of direct marketing (direct email and web marketing), direct sales, and any other field that deals with customer interactions (operations, collections, etc.). In particular, it relates to real-time notification and monitoring when customers are using communication channels such as email and the web that enables intelligent routing of the notification based on business rules.

### BACKGROUND OF THE INVENTION

In the past few years it has become increasingly difficult to implement an effective strategy to contact existing or potential customers. A one percent (1.0%) response rate on email marketing campaigns is considered successful. Even in cases in which a customer has actually responded to marketing attempts with an email or on a web page, there is usually a lag between when the customer has responded and when actual live contact with the customer is established. There is a need to be able to track when a customer is engaged with email and web platforms, notify in real-time the most appropriate individual to contact that customer, and upon contact, allow the individual interacting with the customer to access information about the individual and to record information regarding the details of the contact. This should all be done from one location, automatically update all back-end systems, and allow for fully-detailed reporting.

The present invention leverages the existing technology of email, the web, and a personalized uniform resource locator (“PURL”) to track customer activity in response to marketing campaigns or any activity that brings a customer to a corporate-hosted web page. In real-time, it enables a user to determine if a customer is responding to a marketing campaign, and if the customer is doing so, immediately to notify an employee to initiate a conversation with the customer via telephone. It also provides a single application interface for the employee to receive notification, access information about the customer and to enter information, which is all dynamically added to appropriate business systems. The invention can be used across multiple business segments in any case in which contact with a customer is essential (i.e. marketing, sales, and collections).

### SUMMARY

The present invention is a method and apparatus for a user to manage a customer contact. It begins with the user creating a personalized uniform resource locator (“PURL”) for a customer comprising a domain name, a promotion code and a moniker. The customer is sent the PURL and uses his computer to go online to the domain specified by the domain name.

The customer is directed to a webpage specified by the domain name. The moniker is used to identify the customer and to retrieve information about the customer from the user's computerized customer relationship management database.

An alert is sent to the computer of one of the user's employees notifying the employee that the customer is online on the webpage, which alert contains the information about the customer from the database. The employee then initiates a telephone call to the customer while the customer is online on the webpage.

### BRIEF DESCRIPTION OF THE DRAWINGS

The invention, as well as its advantages, may be better understood by reading the following detailed description of preferred embodiments and the following drawings in which:

FIG. 1 is a flowchart showing the steps of a preferred embodiment of the present invention;

FIG. 2 is a schematic of the system components of a preferred embodiment of the present invention;

FIG. 3 shows a new alert window of a preferred embodiment of the present invention;

FIG. 4 shows a menu display window of a preferred embodiment of the present invention;

FIG. 5 shows a claimed alerts window of a preferred embodiment of the present invention;

FIG. 6 shows a sales opportunity window of a preferred embodiment of the present invention;

FIG. 7 shows a filter window of a preferred embodiment of the present invention; and

FIG. 8 shows a manager routing window of a preferred embodiment of the present invention.

### DETAILED DESCRIPTION OF PREFERRED EMBODIMENTS

Overview

The present invention utilizes a web architecture communicating over a secure channel on top of hypertext transfer protocol (“HTTP”). The most important mechanism for this is the PURL. The engine for this system is email and direct mail contact with a customer or prospective customer. For example, in a marketing campaign, a customer is issued a PURL. This PURL is delivered to the customer by email or direct mail. In a preferred embodiment, the PURL is made up of three parts: a domain name, a campaign/promotion code, and a moniker.

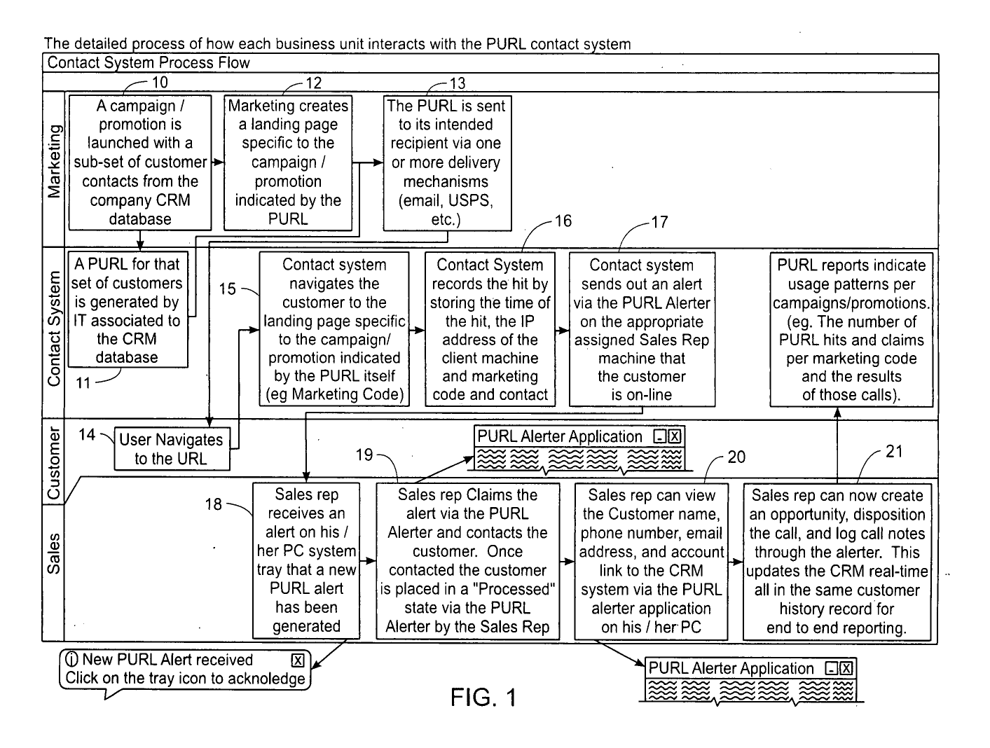

As shown in FIG. 1, when a user launches a promotion, it identifies a sub-set of customers 10 to participate in the promotion, assigns each of the customers in the sub-set a moniker 11, and creates a webpage specific to the promotion 12.

The moniker is unique across all of the user's contacts with the customer. For example, a user would be able to associate a database ID that would allow intelligent population of a web page with information specific to that customer. Whenever a new customer contact is added to a customer relationship management (“CRM”) database, the moniker gets created automatically. There is a one-to-one association between a moniker and a CRM database entry. It is this association that allows the present invention to navigate the thread that connects a contact, a CRM database entry and an opportunity.

The PURL is sent to its intended recipient 13, e.g., a customer, via one or more delivery mechanisms such as email, USPS, etc. When the customer uses the PURL to navigate to a designated domain 14, the customer is directed to a PURL landing page specific to the campaign/promotion indicated by the PURL campaign/promotion code 15. When the user navigates to the PURL landing page, the present invention records the “hit” by storing the time of the hit, the IP address of the prospective customer's computer, the campaign/promotion code, and the moniker 16. Thus, the present invention allows one to measure the efficacy of a campaign/promotion by tracking navigation hits.

A notification is then sent to a PURL Alerter 17. The PURL Alerter will determine where to route an alert. The determination is built upon routing rules that are established by the user. For example, if a sales representative has an ongoing relationship with a customer, the PURL Alerter will only route the alert to that specific sales representative, ensuring the customer experience is consistent. Once the PURL Alerter makes the determination of where to send the alert, it is distributed.

The distributed alert is received by an employee on his computer 18. The employee then initiates a telephone call to the customer while the customer is online on the webpage and at the same time retrieves information about the customer from the user's computerized relationship management database 20. Finally, the employee can disposition the call and enter appropriate information regarding the prospective customer interaction 21. This information is automatically updated in the customer account in the appropriate back-end system.

Hardware

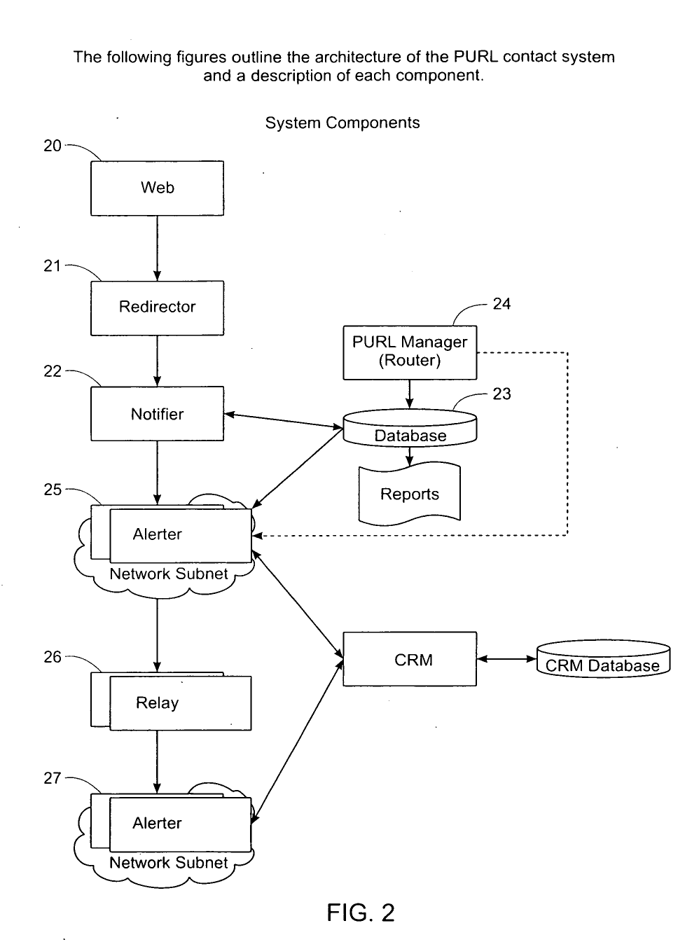

A hardware implementation of a preferred embodiment of the present invention is shown in FIG. 2. Any web page 20 can be utilized as a landing page for PURL responses from customers. For example, all campaigns and promotion pages are hosted within the site, and each set of pages is contained within a folder whose name reflects the marketing campaign/promotion code.

A customer's PURL itself has no web resources associated with it. When a request is made for a web resource that does not exist, the web server will report a “file-not-found” error (a so-called 404 error). A Redirector 21 is configured to be invoked on such errors. The Redirector then maps the PURL's moniker to a database ID and redirects the web request to the landing page also created with the database ID under an identifying code (e.g. marketing campaign/promotion code folder) within the web site, passing along an encrypted version of the database ID to the landing page. The landing page then decrypts the database ID, retrieves any associated contact information, and pre-populates fields on the web page.

In addition to this redirection management, the Redirector also sends a request to a Notifier 22 passing it the encrypted database ID and the campaign/promotion code. It is this request that will result in a notification pop-up on an employee's computer. The Redirector 21 is a .NET 3.5 HTTP Protocol Handler deployed on the web servers.

Whether or not the Notifier 22 propagates the PURL hit is controlled by a configuration that takes the form of an exclusion list. Campaign/promotion codes that are in the exclusion list do not result in the PURL hit being propagated. Each code is deemed “alertable” or “not-alertable” based on this exclusion list.

The Notifier 22 records the PURL hit in the PURL database 23. This record includes the following information: time-stamp, customer IP address, campaign/promotion code, moniker, a unique alert key for the PURL hit, notification threshold, and the alertable state of the hit.

If the PURL hit is alertable, the Notifier 22 sends a PURL hit notification of an IP multicast message on a registered multicast group to the effect that a PURL hit has occurred. The message contains the campaign/promotion code, alert key, and the windows SID of the account manager on the account with which the moniker/contact is associated. The Notifier 22 is a .NET 3.5 Web Service deployed on an internal web server. A PURL Manager Router 24 deals with three sets: a campaign/promotion code set, a group set, and a customer set.

The campaign/promotion set is the set defined within the user's CRM system and is uniquely identified by its code. These are made available to a PURL Administrator through the Router 24. Each such campaign/promotion set can either be in the enabled or disabled state.

The group set is also managed by a PURL Administrator through the Router 24. Predefined teams/groups from the user's CRM system are available for use by default. In addition, ad-hoc groups may be created. Every group has a unique name. A group may be associated with one or more campaign/promotion codes. Each group can either be in the enabled or disabled state.

The customer set is defined within the user's CRM system and is made available to the PURL Administrator by the Router 24. A customer may be associated with one or more sets. Note that members of predefined sets are automatically associated with the set.

The association between campaign/promotion, group and customer sets is maintained in the PURL database 23 and directly influences how a PURL hit is processed by the PURL Alerter 25. The Alerter 25 subscribes to the IP multicast group on which the Notifier 22 sends PURL hit notifications. On reception of an alert, the Alerter 25 retrieves the PURL information from the PURL database 23 based on the alert key that is part of the PURL hit notification.

On start, the Alerter 25 retrieves and caches routing rules that are defined by the PURL Router 25 for the current customer login account. These rules control whether or not a PURL hit is displayed by the Alerter 25. On reception of a new PURL hit, the Alerter 25 uses the cached routing rules to determine if the PURL hit needs to be displayed. If it is displayable, then it is displayed in the “new alert” tab for further processing. The Alerter 25 may also forward PURL hits to one or more Relays 26 for forwarding to one or more other Alerters 27 at other locations.

The Alerter 25 supports saving all alerts to a file for loading back in at a later time. This allows storage across multiple sessions and even across machine reboots. The PURL Alerter 25 is a .NET 3.5 Windows Application deployed on user machines.

Since PURL hits are stored almost in real-time and since it contains sufficient information, one can generate reports of usage patterns.

Interface

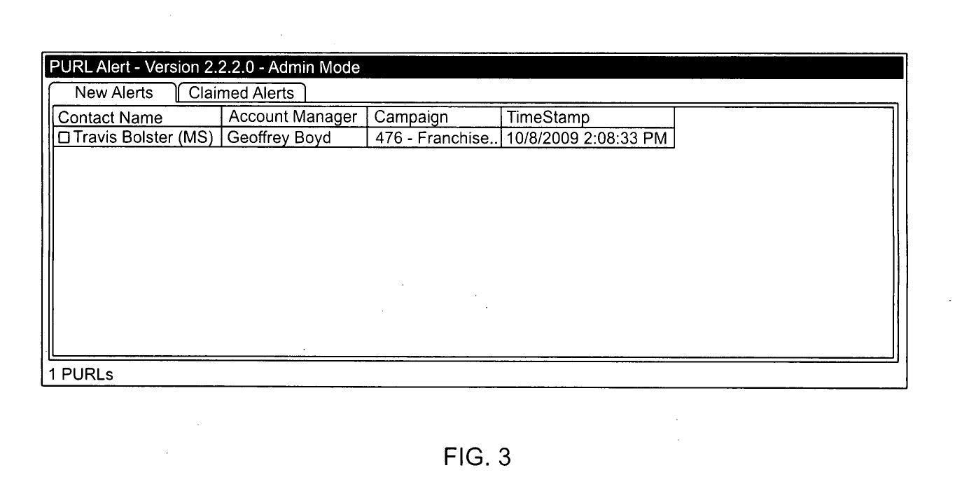

An interface for a preferred embodiment of the present invention runs on a desktop computer, and once started, is represented by an icon on the system tray. The application window consists of two tabs—new alerts and claimed alerts. The new alerts tab will show any customer who has clicked on the PURL that was received via a marketing email. As shown in FIG. 3, the information includes the customer name, sales account manager, marketing campaign/promotion code, and time that the alert was received. It will also include a checkbox for a user's employee to “claim” the alert.

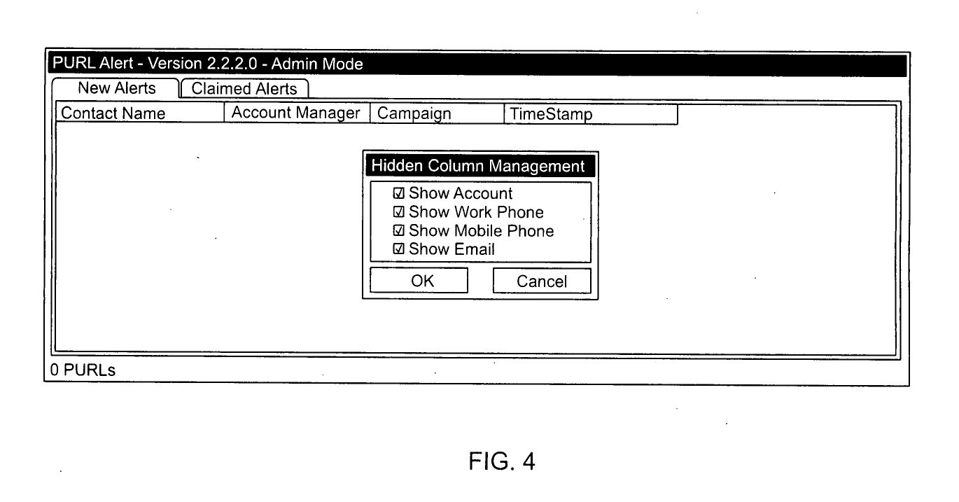

Sales representatives are able to filter the display so that they only display the desired columns. Right clicking on the column headings causes the menus display shown in FIG. 4. Clicking on the checkbox next to each data field causes the columns to display.

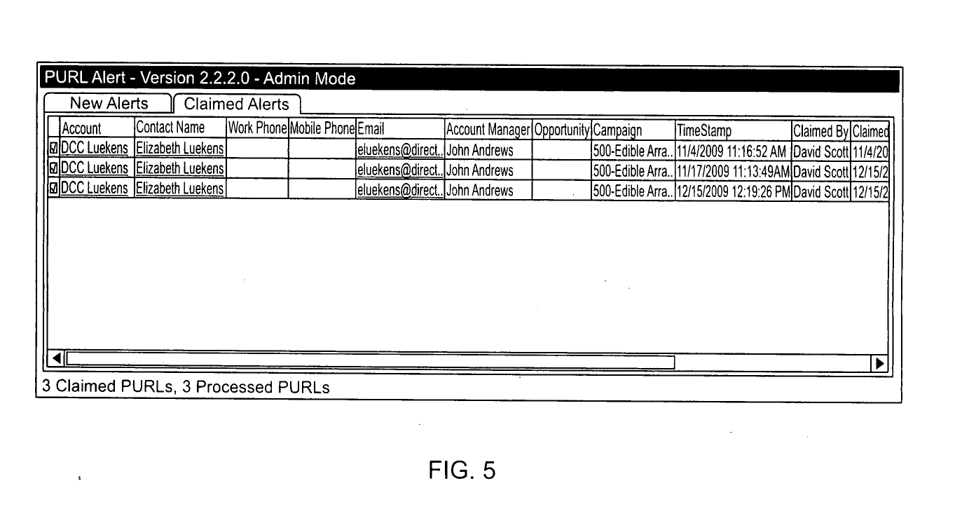

The second tab, claimed alerts, will list all of the alerts in which the alert was claimed by a user's employee. In FIG. 5, the tab includes the following information: customer name, phone number, cell phone, email, account name, sales account owner, CRM opportunity link, marketing campaign/promotion name and code, time stamp when alert claimed, claimed by (name of user's employee), claimed on (date and time), processed on (date processed), and term code (disposition of phone call). The first field will also include a checkbox to indicate the alert has been processed. This indicates a call has been placed to that customer. An employee cannot claim a new alert until his previous alert has been processed. In this preferred embodiment, all of the customer names and company names are hyperlinked back to a CRM database. The email field is linked back to the corporate outlook system for quick emailing. At any time the employee representative can select “create” in the opportunity link and the opportunity window launches directly from the back-end system. Once the alert is processed, a call detail screen launches directly from a core contact system allowing the employee to enter all of the contact details including the final disposition of the call. While viewing the data, the employee can sort the data in the window by selecting any of the column headings (e.g. name). This will sort alphabetically from A-Z by selecting once and Z-A by selecting a second time. Also, any record that is on the internal list for no solicitation will be marked in red to remind the sales representative.

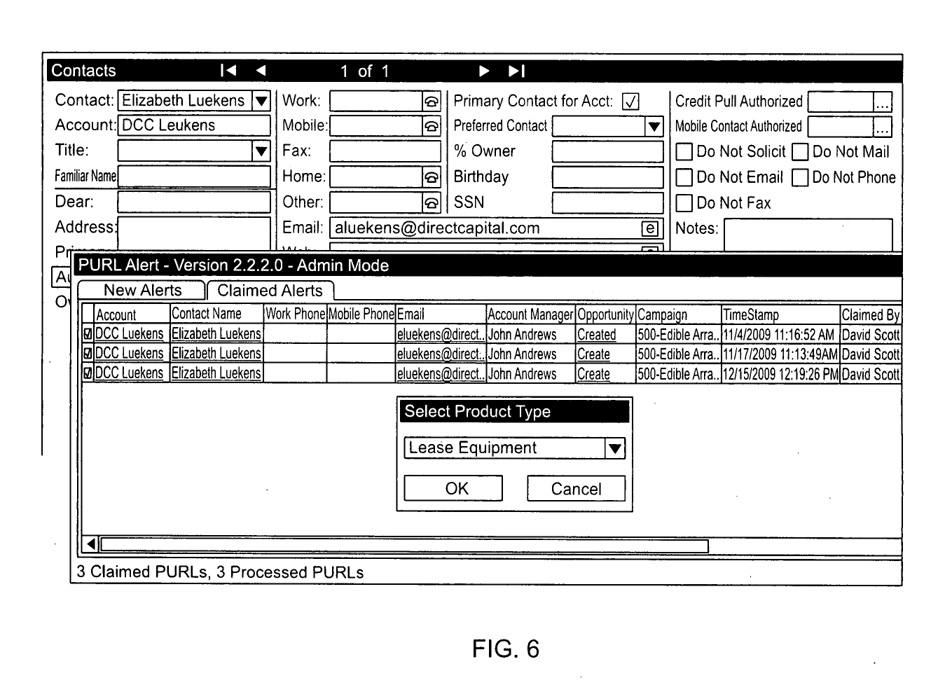

At any time while in the “claimed” tab, a sales representative can also select a link that initiates an activity in the back end system. As shown in FIG. 6, one can create a sales opportunity in the CRM system by clicking on “create” through the PURL Alert tool in the appropriate customer row.

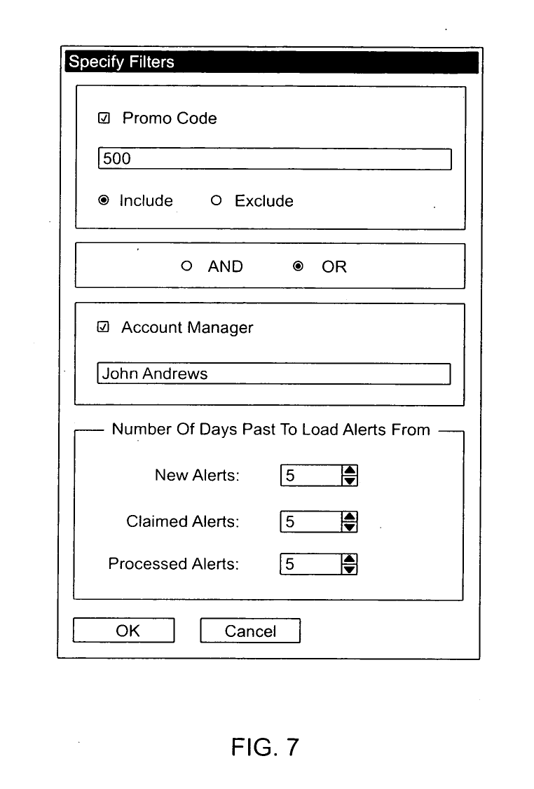

The PURL Alert tool also gives one the ability to filter the alerts that each specific sales representative can view. By right-clicking on a tray icon, one can select “Filters.” The Filter window shown in FIG. 7 then appears.

In this example the employee can select only the marketing codes that he would like to “include” in the tab window or “exclude.” For example, many employees will only be responsible for monitoring a specific campaign and so will set up the filter to display only that marketing code. The PURL Alert tool will also allow the sales representative to determine how far back in days to display the appropriate alerts. In this example, only the last 5 days of new, claimed, and processed alerts are displayed. Also by selecting the “account manager” checkbox, one can enter the name of an account manager from the CRM database and only display alerts with that account manager.

The PURL Alert tool also includes “user mode” and an “administrator mode” for the user's software. The “administrator mode” allows an administrator to see all alerts and claim any alert. It is intended for system administrators and managers properly to monitor the system. The “user mode” will allow an employee to see only the alerts in which he is the assigned account owner. Thus, employees need not view alerts not intended for them.

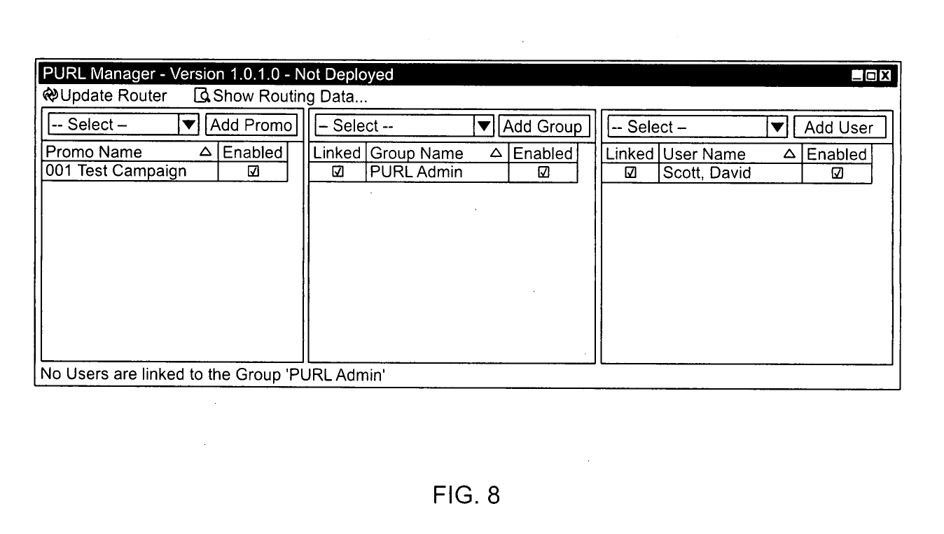

The system administrator will also have access to a separate tool called the PURL Manager (Router) as shown in FIG. 8. This tool allows the administrator to set up routing “groups” consisting of marketing campaigns/promotions and end users. The marketing promotion codes are dynamically fed from the CRM so that any new codes added by the marketing team are automatically available. Also, all system users and workgroups that are built in the CRM are automatically added to the PURL Manager. The administrator has the ability to create “routing groups” linking the marketing promotions to the appropriate users/workgroups. The groups are created from scratch and can be named by the user to assist in the routing of PURL alerts to the most appropriate customers.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A method for a user to manage a customer contact comprising,
creating for a customer, and sending to the customer, a personalized uniform resource locator comprising: a domain name, a promotion code and a moniker,
directing the customer to a webpage specified by the promotion code when the customer uses the personalized uniform resource locator to go online to a domain specified by the domain name,
using the moniker to identify the customer and sending an alert to an employee's computer that the customer is online on the webpage,
retrieving information about the customer from a computerized customer relationship management database and sending the information to the employee's computer, and
having the employee initiate a telephone call to the customer while the customer is online on the webpage.

2. The method of claim 1 further comprising,
disposing of the call and entering from the employee's computer a description of the disposition in the database.

3. The method of claim 1 further comprising,
sending the alert to an employee's computer wherein the employee is selected by routing rules specified by the user.

4. The method of claim 1 further comprising,
recording directing the customer to the webpage by storing the time, the IP address of the customer's computer, the promotion code and the moniker.

5. A system for a user to manage a customer contact comprising,
a webpage,
a personalized uniform resource locator sent to a customer comprising: a domain name, a promotion code and a moniker,
a redirector on a computer that:
redirects a customer to the webpage when the customer uses the personalized uniform resource locator to go to a domain specified by the domain name, and
sends a report of the customer being redirected to the webpage,
a notifier on the computer that receives the report, determines, based on user generated rules, whether or not the customer being redirected to the webpage is alertable, and sends notification if it is alertable,
an alerter on the computer that receives the notification, determines, based on user generated rules, whether or not the customer being directed to the webpage is displayable and sends an alert to an employee's computer if it is displayable, which alert contains information about the customer.

6. The system of claim 5 further comprising,
a telephone for the employee to call the customer while the customer is on the webpage.

7. The system of claim 5 further comprising,
a relay for forwarding an alert to additional alerters at other locations.

8. The system of claim 5 wherein the alerter stores the time, the IP address of the customer's computer, the promotion code and the moniker.
